(19) United States
(12) Patent Application Publication
(10) Pub. No.: US 2017/0293941 A1
(43) Pub. Date: Oct. 12, 2017

(54) System and Method for Targeted Personalized Ads

(71) Applicant: Ohzone, Inc., Santa Clara, CA (US)

(72) Inventors: Kevin P. Acken, Mountain View, CA (US); Warangkana Tepmongkol, Santa Clara, CA (US)

(21) Appl. No.: 15/436,547

(22) Filed: Feb. 17, 2017

Related U.S. Application Data
(60) Provisional application No. 62/296,013, filed on Feb. 16, 2016.

(51) Int. Cl. G06Q 30/02; G06F 17/30; G06F 17/50

(52) U.S. Cl. CPC G06Q 30/0269; G06F 17/5009; G06F 17/30312

(57) ABSTRACT

A system for generating electronic advertisements for wearables customized for a selected user on a network, the system including a first server configured to receive requests from a device to share wearables with the selected user on a network; a first server coupled to receive requests for advertisements from the first server and communicate to the selected user on the network, the second server comprising: a first database configured to store a plurality of user models, each user model being a three-dimensional model of a portion of a human body; a second database configured to store a plurality of wearable models, each wearable model being a three-dimensional model of a wearable; a third database configured to store advertising campaigns; a processor configured to: receive a three-dimensional model of a portion of a human body and the model of the wearable for an associated user; morph the clothing to fit the personalized data for the target user in response to the sharing request; and render the image of the clothed body.

### CROSS-REFERENCE TO RELATED APPLICATIONS

This U.S. non-provisional application claims the benefit of U.S. provisional application no. 62/296,013, filed on Feb. 16, 2016, the contents of which are expressly incorporated by reference herein. This U.S. non-provisional application is related to the following commonly-owned U.S. patent applications, which are hereby expressly incorporated by reference in their respective entireties:
(1) U.S. non-provisional application entitled “System for 3D Clothing Model Creation”, filed on Feb. 17, 2017, serial number ______ , which claims the benefit of U.S. provisional application no. 62/296,001, filed on Feb. 16, 2016;
(2) U.S. non-provisional application entitled “System and Method for Virtually Trying-On Clothing”, filed on Feb. 17, 2017, serial number ______ , which claims the benefit of U.S. provisional application no. 62/296,005, filed on Feb. 16, 2016; and
(3) U.S. non-provisional application entitled “Virtually Sharing Customized Clothing”, filed on Feb. 17, 2017, serial number ______ , which claims the benefit of U.S. provisional application no. 62/296,008, filed on Feb. 16, 2016.

### BACKGROUND

### Technical Field

This disclosure relates generally to the field of representing a graphical object display modeling using mathematical algorithms. More particularly, the disclosure relates to advertising clothing using models of advertised clothing and other wearables and personalized avatars of the recipients.

### Background Art

### Description

One of the basic needs of human beings is clothing. In 2016, annual apparel sales were expected to exceed $1.4 trillion globally, and more than $300 billion in the United States. In 2015, apparel became the highest selling category in online retail within the United States, reaching about $75 billion in annual sales.

There are advantages in selling and purchasing clothing online. From the customers point of view, the time and effort to travel to the store may be avoided. They may purchase the clothing directly on their computer wherever they happen to be. From the retailer's point of view, the need for brick and mortar stores may be avoided altogether or reduced in number, thereby potentially saving retail store rents. The self-service nature of online sales may reduce the need for retail sales staff, and the associated costs.

There may also be disadvantages in selling and purchasing clothing online. In contrast to a customer who visits a brick-and-mortar retail store, an online customer cannot physically try on clothing before purchase. The lack of pre-sales fitting may increase the return rate because customers find that they are not satisfied with the fit or look of the clothing when they receive the order. The extra shipping and handling cost and effort of returned items can discourage purchases in the online sales channel, increase wear on unsold merchandise, and reduce profits.

E-commerce websites often display images of clothing dressed on mannequins or human models so that potential customers can visualize the clothes as they would be worn. These images are often generated by the manufacturer or the retailer to promote the product. These photographed professional models that may not represent the body type of the typical customer. However, many retailers also take photos of so-called plus-sized models and others that may represent more typical customers. These efforts may help potential customers better visualize the clothing on themselves.

When a potential customer visits a retail store, they typically have the option to try on in-stock clothing. They can verify which size of any such garments fit them and can see how the selected garment looks on them. They can try on clothing and get immediate feedback from the friends or family who visit the store with them. However, online purchases are fulfilled through centralized warehouses that may provide an advantage in terms of consolidated inventory. Consolidated inventory may allow a wider range of stocking units (SKUs) and sizes than can cost-effectively be maintained in inventory in each of numerous smaller retail stores.

Clothing retailers often provide generous return policies for clothing that is purchased online. This may encourage consumers to make online purchases of clothing despite the lack of a pre-sales fitting process.

### SUMMARY

Current clothing and apparel electronic advertisements typically consist of text description of the products, one or more 2D standalone images of the item, and one or more 2D images of advertising models wearing the item. In some cases, generic 3D models of the item or advertising models wearing the item that can be rotated or scaled. These advertisements are effective because of the high quality, appealing imagery, and because one advertisement can be sent to an entire customer base without modification. The disadvantage of this approach is that the advertising models are an unrealistic visual for majority of the customer population, and the advertisements are served with little demographic feedback on whether the item is available in a size that would fit the advertisement viewer, resulting in poor clothing fit, lower satisfaction, and higher item return rate.

An advertising system is disclosed in which a retailer can send electronic advertisements to customers that contain 2D images or 3D frames that show a 3D rendering of the potential customer wearing the advertised item in the correct size, and/or show the advertised item being worn by persons that the customer may shop for, such as children or other family members, close friends, etc. This provides the customer an accurate view of the item that is also sized correctly, leading to higher customer satisfaction.

In some embodiments, the advertising system that can give real-time feedback on the number of target customer's that fit the advertised item to scope the advertisement for effectiveness.

In a preferred embodiment, personalized 3D visual ads where the target user sees their avatar wearing a correctly sized advertised item. In some embodiments, advertisements are only shown to potential customers after verifying that the item is available online or at a retail store local to that potential customer.

In some embodiments, the retailer can specify a set of clothing, such as the latest available seasonal line, in a way that the server advertisement shows the avatar wearing each of the advertised items in sequence, switching after a pre-determined timeout, and/or allow the user to interactively change the clothing of the 3D avatar in the advertisement selecting among the advertised items.

In a preferred embodiment, the advertisement would be an interactive ad, using 2D or 3D frames, enabled by the application that is displaying the ad, whether it is a self-contained application, a website, an email attachment, an application plugin, or other means of embedding the advertisement using the native device's input mechanisms. The interactive frame can also be integrated into existing advertising channels such that it can be embedded in, or used in conjunction with current electronic advertising components.

In a preferred embodiment, potential customers register a profile and create a personalized avatar. In a preferred embodiment, the personalized avatar is created and rendered with selected articles of clothing and other wearables as disclosed in U.S. non-provisional application entitled “System for Virtually Trying On Clothing”, serial number ______ , filed on Feb. 17, 2017.

In a preferred embodiment, the wearables are modeled using difference tables as disclosed in U.S. non-provisional application entitled “System for 3D Virtual Model Creation”, serial number ______ , filed on Feb. 17, 2017.

In a preferred embodiment, the wearables displayed in an advertisement to a registered user may be forwarded by the recipient to family and friends so that they can see a personalized virtual model of themselves wearing the shared wearable as disclosed in U.S. non-provisional application entitled “System and Method for Virtually Sharing Customized Clothing”, serial number ______ , filed on Feb. 17, 2017.

However, the invention may be performed using other methodologies to create avatars and wearable models, and apply selected wearable models to the avatar.

### DESCRIPTION OF THE DRAWINGS

FIG. 1 illustrates one embodiment of the system for creating and distributing targeted personalized ads.

FIG. 2 illustrates one embodiment of a block diagram for a targeted personal advertisement.

FIG. 3 illustrates one embodiment of a campaign database.

FIG. 4 is a flowchart of one embodiment of a process for creating an advertising campaign.

FIG. 5 is a flowchart of one embodiment of a process for creating and distributing targeted personalized ads.

FIG. 6 is a diagrammatic representation of an embodiment of a machine 900, within which a set of instructions for causing the machine to perform one or more of the methods discussed herein.

### DETAILED DESCRIPTION

Various examples of embodiments will be described below with reference to the drawings. The following exemplary embodiments are illustrative and are not to be construed as limiting.

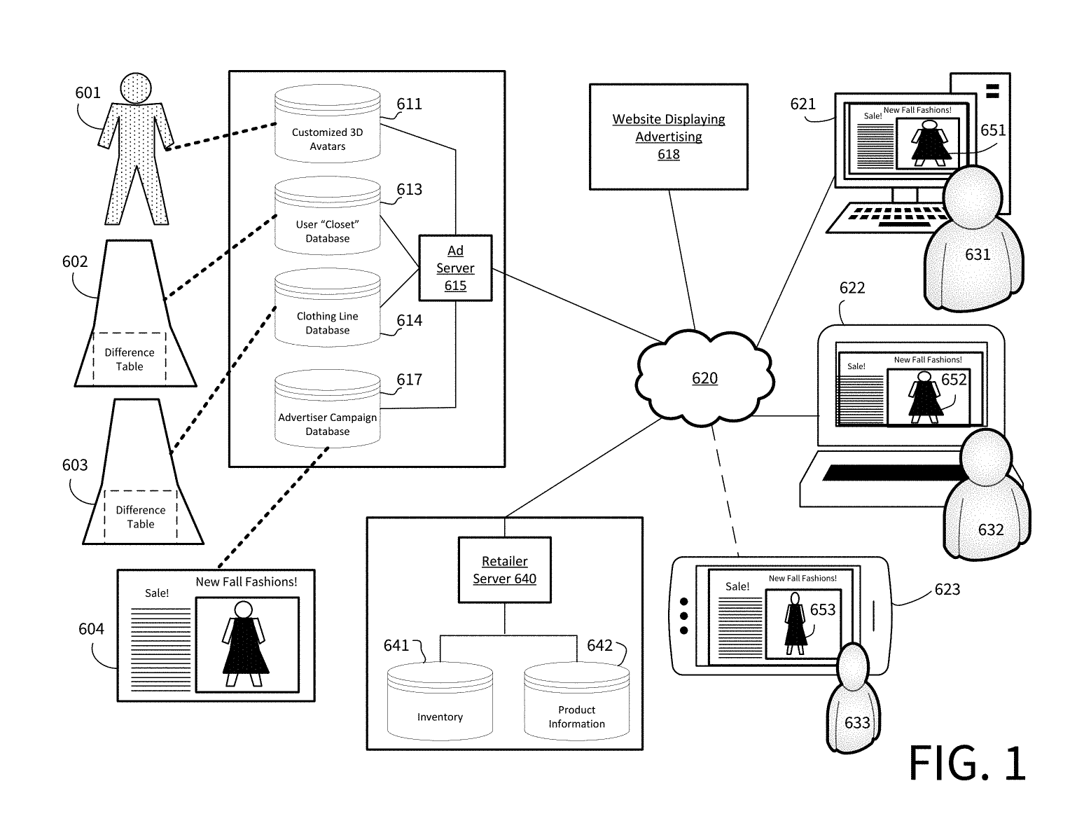

FIG. 1 illustrates one embodiment of the system for creating and distributing targeted personalized ads.

An ad server 615 is coupled to the Internet 620 to communicate with various client devices such as a desktop 621 operated by a user 631, a laptop 622 operated by a user 632 and a smart phone 623 operated by a user 633.

The ad server 615 is coupled to the Internet 620 to distribute ads through one or more websites 618 that display advertising.

The ad server 615 also communicates with a retailer server 640. The retailer server 640 communicates with an inventory database 641 and product information database 642 to provide product information and inventory status to the server 615 and in some cases as part of a website or customer portal accessible directly by the user 631, the user 632 and/or the user 633 as well as other people connected via the Internet 620.

The server communicates with a customized 3D avatars database 611, a clothing line database 614 and the user “closet” database 613, an advertiser campaign database 617, and a user profile database (not shown).

A retailer that wants to advertise some or all of the clothing and other wearables in their product line would create and upload 3D models of clothing and other wearables into the clothing line database 614. This can be accomplished by using mobile cameras that capture 3D depth, 2D image to 3D algorithms, the user selecting pre-generated 3D models that match their measurements, or other means.

In a preferred embodiment, the models of the wearables are created according to the disclosure in U.S. non-provisional application entitled “System and Method for Clothing Model Creation”, serial number ______ .

In addition to the 3D models, additional characteristics of the item may be input into the clothing line database 617 to help target registered users that would be most interested in the product, determine the sizes available, fit characteristics, and additional characteristics that may be relevant to the consumer. This information may include (1) categorize item as targeted towards men, women or children; (2) categorize item by type of clothing, such as pants, shirt, blouse, and dress; (3) categorize the item bilayer such as underwear, base layer (e.g. shirt, pants, dress), mid-layer (e.g. sweater, vest, sports jacket), shell layer (e.g. outer jacket, coat); (4) material such as fabric type, fabric texture or pattern; (5) available size measurements or general size descriptions (e.g., small, large, size 0, size 2, etc.); (6) specific measurements (e.g. sleeve length, dress length); (7) additional marketing information including advertising copy and 2-D images of the item; (8) manufacturing source; and (9) pricing information.

The user profiles database includes registration information for the registered users, including the user 631, the user 632 and the user 633. It may also include social network information including connections between the registered users and connections to a social network.

The user “closet” database 613 includes models of various articles of clothing or other wearables that are registered as owned by the client and is figuratively if not literally in their closet. In a preferred embodiment, the wearables created according to the disclosure in U.S. non-provisional application entitled “System and Method for Virtual Clothing Try-On”, serial number ______ . In some embodiments, the user “closet” database 613 includes a list of SKUs that are owned by each user, and the associated model is accessed by looking up that SKU in the clothing line database 614.

In order for the recipients to receive the personalized 3D model showing them trying on particular clothes, they must register to create a user profile on the ad server 615. The user will need to upload or create an avatar 601 which is a 3D model of their body personalized and stored in the customized 3-D avatars database 611 for each of the registered users. In some embodiments, the avatar 601 is generated using 3-D depth scanning or 2-D image interpretation of the registered user's body. In other embodiments, the avatar 601 is generated based on body measurements such as bust size, waist size, hip size and inseam length. In a preferred embodiment, the avatar 601 is created according to the disclosure in U.S. non-provisional application entitled “System for 3D Virtual Model Creation”, serial number ______ . Other methods of generating an avatar may be used.

A retailer or someone acting on their behalf upload an advertising campaign to the advertising campaign database 617.

A retailer or someone acting on their behalf would upload wearable models 603 to the clothing line database 614. These wearable models 603 would include the specific wearables that the retailer would like to promote in the advertising campaign. This may include all the wearable models uploaded on the system or a specific subset for promotion in the advertising campaign. This selection may not only be defined by specific garments, but specific sizes, colors, or any other categorization criteria stored with the items in the product line database 617.

In some embodiments, the ad server 615 searches the customized 3D avatar database 611 to identify demographic information of the users that match the criteria to receive advertisements for the configured campaign. For example it might state that the campaign will match 25,314 registered users in the customized 3D avatar database 611, and the 64% are men, and 42% are age 13-20, and 36% are age 21-30. This information may be used to fine tune the targeting criteria.

The server receives a list of 1 or more items, identified by a unique item id, and for each of these items, receives a sub-list of target sizes. For each item id in the list from (1), the server retrieves the measurement data for that item id from the Clothing Information Database. The server then calculates the minimum and maximum size characteristics of the item id based on the target sizes, the server performs a coarse grain search on the User Avatar database based on the avatar gender and avatar size to create a list of candidate avatars. If the avatar size is greater than the minimum item size and less than the maximum item size, then that avatar is included in the coarse grain list. Depending on the number of coarse grain hits, the list may be sub-sampled to reduce the list size. For each avatar in the coarse grain list, the server does a coarse grain fitting of the item id on the avatar. The server selects the minimum target size that is greater than or equal to the avatar size, an using a quality fit algorithm, determines if the item id will fit on the avatar. If a quality fit is found, then the avatar is added to a successful fitting list. When adding the avatar to the list, the avatar's owner demographics is accumulated. After all the avatars and items have been processed, or after the successful fit list exceeds a certain threshold, the list size and demographics information is returned to the advertiser's app.

In some embodiments, the advertiser or someone acting on their behalf can design an advertisement from scratch or based on a previously saved template, using the user interface at the ad server 615. The template is saved in the advertiser campaign database 614,

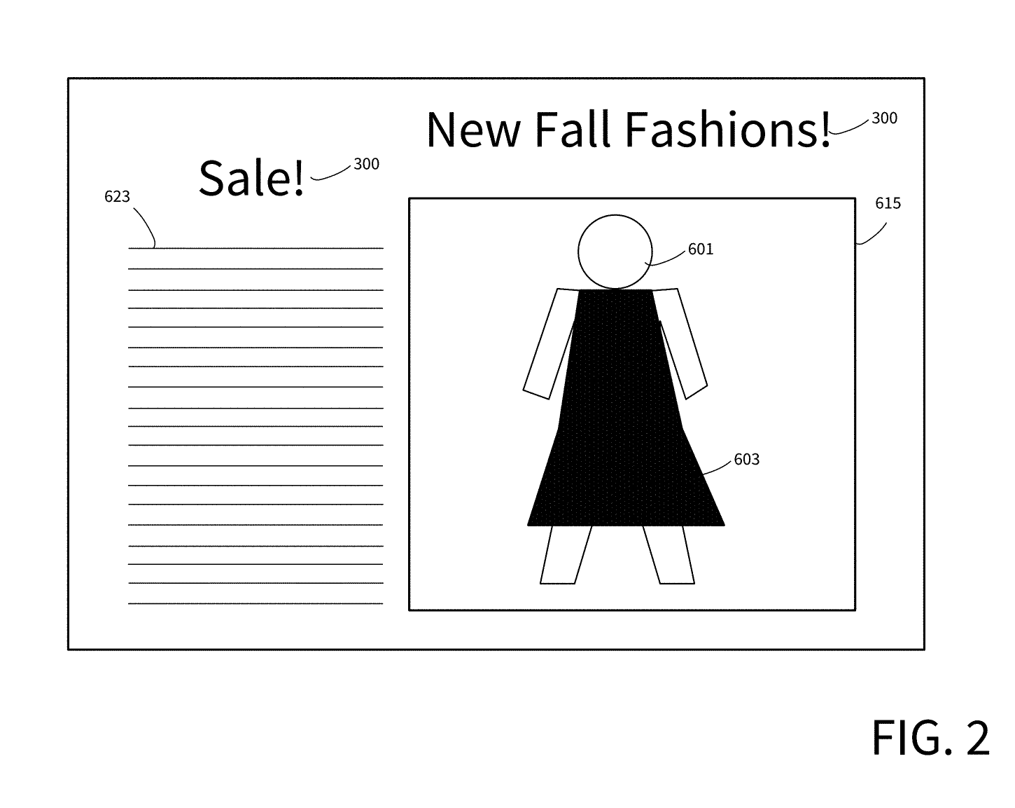

FIG. 2 illustrates one embodiment of an advertisement stored in the campaign advertisement database 614. The advertisement may include some headlines 300 some advertising copy 301, and a 3-D frame 615 including an avatar 601 wearing a wearable model 603.

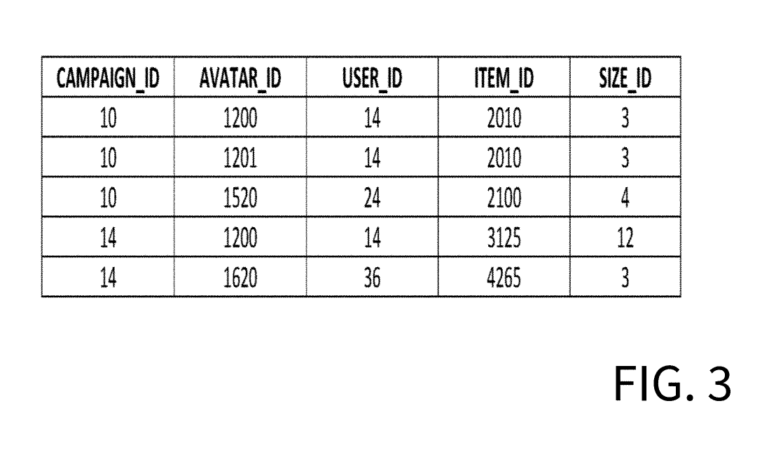

FIG. 3 illustrates one embodiment of the campaign definition table stored in the advertiser campaign database 614. All scheduled advertisement campaigns are sent to the server and stored in advertiser campaign database 614, each referenced by a unique advertiser campaign id.

A campaign ID is a unique identifier that associates that entry in the table with a specific campaign.

An avatar ID is a unique identifier that associates that entry in the table with a specific avatar personalized to an individual.

A user ID is a unique identifier that associates that entry in the table with a specific registered user. In some cases a registered user may have multiple avatars associated with them because they make purchases for their children or spouse and manage the avatar on their behalf.

An item ID is a unique identifier that associates that entry in the table with a specific product.

A size ID is a identifier that associates that entry in the table with a specific size.

Each combination of factors in an entry define advertisement parameters that may be used to create a specific advertisement using the template also defined for the campaign.

The invention contains an interface for applications or web site that allow the user's device to query the server for a targeted personalized advertisement. The interface requires that the user is securely identified on the device or web site, and the user id is sent to the server when querying for an advertisement. When receiving an advertisement query, the server first searches the CAMPAIGN_USER_TARGET database using the user id as the search key. The results of that search are potential campaign advertisements that can be served to the user. If there are no results, the system can either return a general advertisement based on other information known about the user, or can decline to send any advertisement.

If the CAMPAIGN_USER_TARGET search is non-empty, then one entry is selected for display. This can either be done through random selection, or weighted by campaign priority.

Base on the entry selected, the server will then load the avatar information from the USER_AVATAR database, and the item information from the CLOTHING_INFORMATION database.

Using a fine grain fitting algorithm, the size information of the item is used to fit the item model's vertices on the avatar model's vertices, and a combined 3D model is created. This algorithm can be run on either the server CPUs, or sent for processing to the target user's device.

The template layout of the target campaign is loaded from the CAMPAIGN database, and the 3D model is included into the template 3D frame, and the completed advertisement is returned to the user's device.

After generating and sending the advertisement, the server CAMPAIGN_USER_TARGET database is updated to reflect that the advertisement was sent.

The user will see the advertisement on their device, with their 3D avatar wearing the advertised item, listing the size of the item that fits, and providing the additional advertisement information from the advertiser's template.

The user 631, who is larger, would have an advertisement with a 3D model 651 displayed on their desktop computer 621 that represents their larger body with a larger size of the wearable 603 being advertised. The user may also request through the user interface that the 3D model 651 be displayed using the advertised wearable 603 in combination with other wearables in the clothing line database 614 or wearables in the user “closet” database 613 that are available to the user 631. The selections of wearables to be displayed in combination with the shared wearable would be made independently of the same types of choices made by the user 632 or the user 633

The user 632, who is medium sized, would have an advertisement with a 3D model 652 displayed on their notebook computer 622 that represents their medium body with a medium size of the wearable 603 being advertised. The user may also request through the user interface that the 3D model 651 be displayed using the advertised wearable 603 in combination with other wearables in the clothing line database 614 or wearables in the user “closet” database 613 that are available to the user 632. The selections of wearables to be displayed in combination with the shared wearable would be made independently of the same types of choices made by the user 631 or the user 633

The user 633, who is small sized, would have an advertisement with a 3D model 653 displayed on their mobile phone 622 that represents their smaller body with a small size of the wearable 603 being advertised. The user may also request through the user interface that the 3D model 651 be displayed using the advertised wearable 603 in combination with other wearables in the clothing line database 614 or wearables in the user “closet” database 613 that are available to the user 633. The selections of wearables to be displayed in combination with the shared wearable would be made independently of the same types of choices made by the user 631 or the user 632.

In some embodiments, the viewer of the advertisement can manipulate the directional view of the 3D user model wearing the advertised item such as 360 degree rotation across any X, Y, or Z axis, panning the display, zooming in and out. The viewer can adjust the lighting of the view to see the 3D user model and advertised clothing in different lighting conditions, such as daytime, nighttime, indoor, outdoor. The viewer can adjust the background of the view, to show the 3D user model and advertised clothing with different scenery, such as output nature, outdoor urban, indoor, stage. The viewer can change the motion of the 3D user model and advertised clothing with selected animation, such as walking, running, twirling, dancing, so that the view can see how the clothing responds to a variety of motions.

In some embodiments, the user “closet” database allows for the user to submit their own models of wearables that may not be included in the clothing line database 614. A user may want to do this for wearables they own which may be from a manufacturer or retailer that has not uploaded official models to the clothing line database 614. In some embodiments, a user may grant other users permission to access and try-on wearables they have stored in the user “closet” database 613. This might be useful for friends that may borrow clothes from each other.

In some embodiments, clothing models may be submitted by having third-party services scan the wearables using the same or similar techniques as the manufacturers or retailers. For example, users may bring their wardrobe into the third-party service to have the wearables scanned and the associated models uploaded to the user “closet” database 613 associated with their profile.

A user might not only be interested in how the advertised wearable looks by itself, but rather how the it looks when worn with other specified wearables. For example, if a blouse is advertised to a user, that user may want to virtually try it on with particular pants they select from their closet. Users can virtually try-on the advertised wearable in combination with wearables that are represented in the clothing line database 614, or items in their wardrobe that may also be in the clothing line database 614 or the user closet database 613. Thus, the sharing of the wearables not only helps sales of the advertised wearable, but may also encourage sales of related clothing items.

The clothing line database 614 includes models of various stock keeping units (SKUs) for articles of clothing or other wearables. In a preferred embodiment, the models of the wearables are created according to the disclosure in U.S. non-provisional application entitled “System and Method for Virtual Clothing Try-On”, serial number ______ .

The ad server 615 pulls together a 3D personalized ad by querying the advertiser campaign database 617, loading the avatar 601 that is personalized for the recipient of the advertisement, loading wearable models 603, and possibly remotely accesses the retailer server 640 to include product information and inventory status for the advertised wearable(s) in the recipient's size at local retail stores, and creates and servers an ad to the targeted register users.

In some embodiment, the system keeps track of previous clothing purchases of the user, and allows the users to upload other clothing that they own, and thus can serve advertisements to the user wearing the advertised clothing in combination with clothing items already possessed by the user.

The viewer can change which 3D user model is wearing the advertised item, and the advertised item will automatically be adjusted in size to fit the selected user models. The viewer can forward the advertisement to others that they feel will be interested in the advertised items. If the recipient of the forwarded advertisement has a 3D user model in the system, then the forwarded advertisement will show the recipient's 3D user model wearing the advertised clothing, correctly adjusted for size.

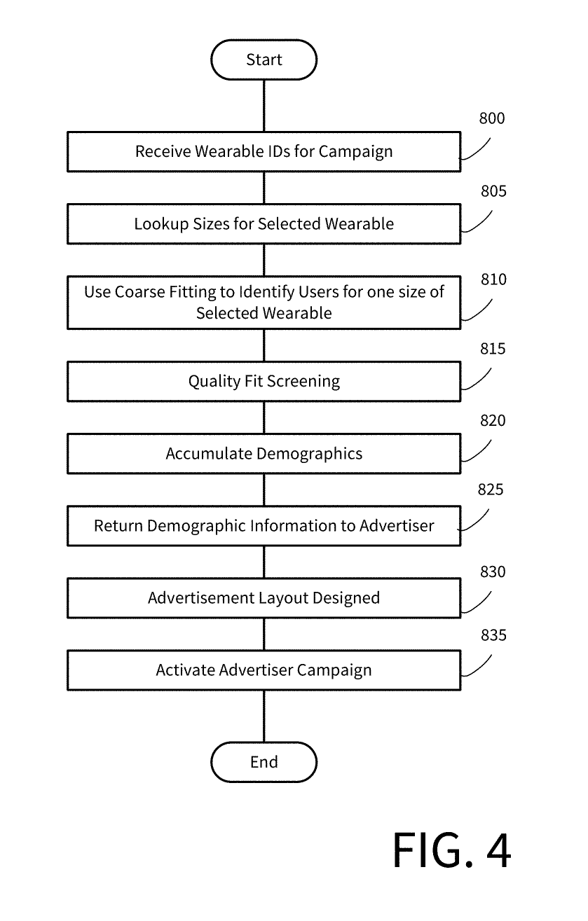

FIG. 4 illustrates one embodiment of a flow chart for creating a new advertising campaign.

In step 800, at least one wearable ID is received for a campaign. The wearable IDs identify specific wearables in the advertiser campaign database 617. These wearable IDs are the ones selected for advertising in the campaign.

In step 805, sizes for the selected wearables are looked up.

In step 810, coarse fitting is used to identify users for one of the promoted sizes of the selected wearables.

In step 815, a quality fit screening is performed.

In step 820, demographics are determined for the registered users that fit one of the promoted sizes of the selected wearables with sufficient quality. In some cases, quality is determined by the expected comfort level.

In step 825, the demographic information is returned to the advertiser for evaluation. In some cases, the advertiser may modify the selected products and sizes to meet their demographic goals.

In step 830, the advertisement layout is designed as described herein. Other templates and formats may be used.

In step 835, the advertising campaign is activated. The ad server begins serving ads to the target demographic according to the methods described herein.

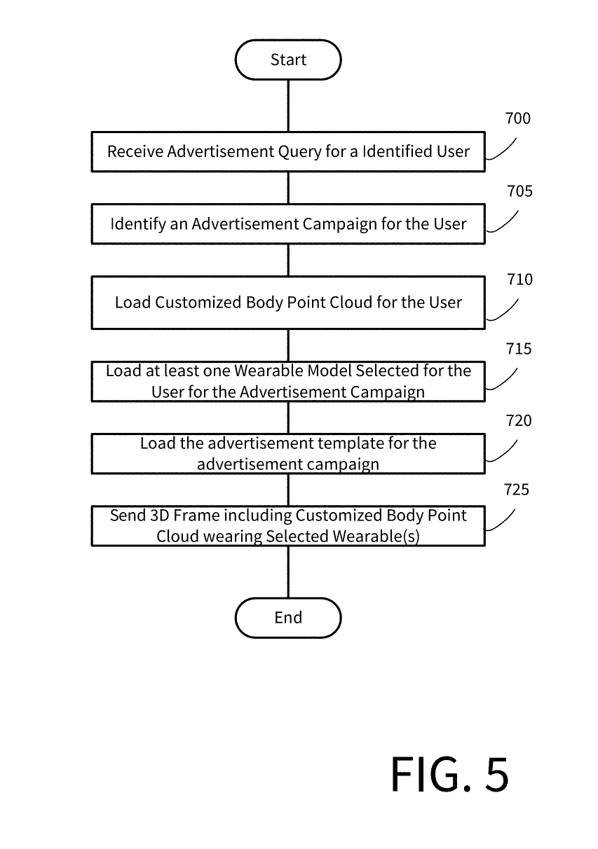

FIG. 5 illustrates a flowchart of one embodiment of a process for serving an advertisement.

In step 700, an advertisement query is received for an identified user. In some embodiments, the advertisement query may be received to serve and add on a webpage the user visits on our website 618 displaying advertising. In other embodiments, the advertisement query may be received when the user accesses an application on their smart phone 623, or other connected device.

In step 705, and advertisement campaign is identified for the identified user. In a preferred embodiment, the advertising campaign is identified by searching for the unique user ID in the advertiser campaign database 617 to identify an entry that matches. In a preferred embodiment, an entry will identify a campaign, avatar, wearable and size.

In step 710, a customized 3-D avatar is loaded for the identified user.

In step 715, the selected wearable model is loaded for the identified campaign.

In step 720, the advertisement template is loaded from the advertising campaign database.

In step 725, a 3-D frame with the customized 3-D avatar and the selected wearable model is sent to the user in an identified advertisement.

The advertisement is viewed on the client device as described herein.

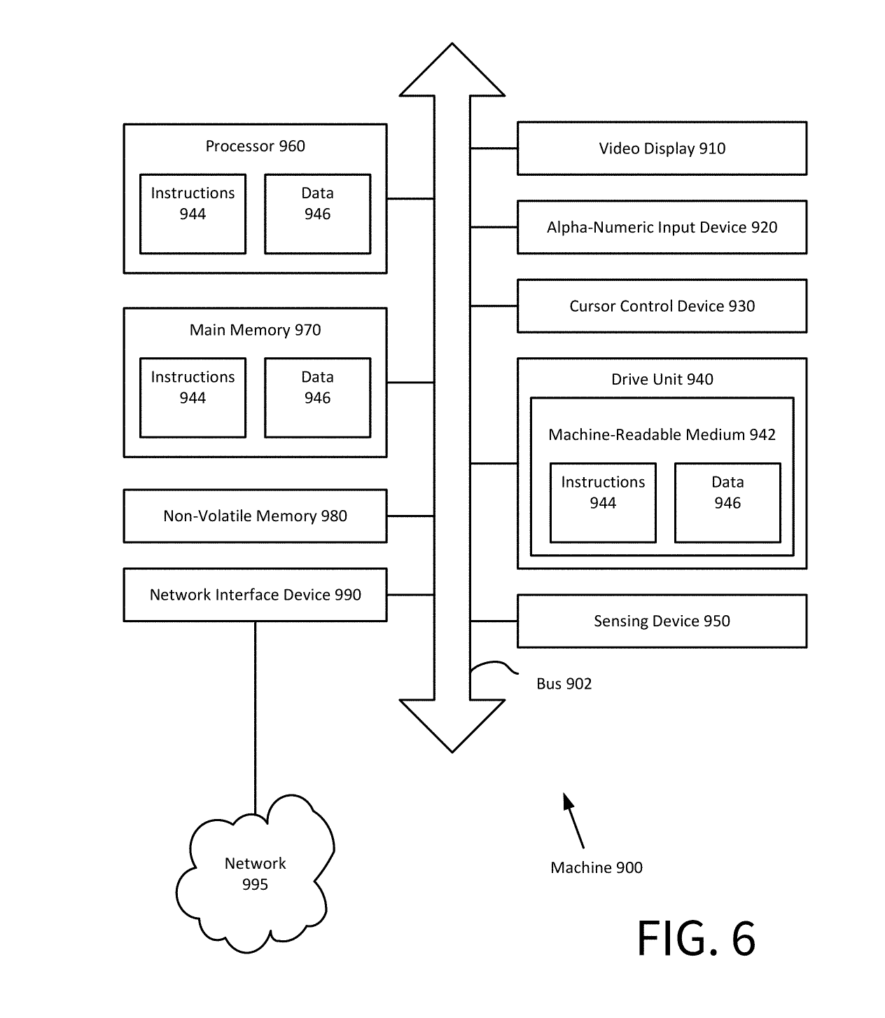

FIG. 6 is a diagrammatic representation of an embodiment of a machine 900, within which a set of instructions for causing the machine to perform one or more of the methods discussed herein. The machine may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with a server to facilitate operations of the server and/or to access the operation of the server. In some embodiments, the machine may act as a server for some functions and a client for other functions.

In some embodiments, the machine 900 is the system 150 according to an embodiment as described herein or a component of such systems, such as one or more processors that make up the system 150. In other embodiments, the machine 900 is the database system 110 according to an embodiment as described herein.

The machine 900 includes a processor 960 (e.g., a central processing unit (CPU), a graphics processing unit (GPU) or both), a main memory 970 and a nonvolatile memory 980, which communicate with each other via a bus 902. In some embodiments, the machine 900 may be a cluster of computers or comprise multiple processors or multiple processor cores. In one embodiment, the machine 900 also includes a video display 910, an alphanumeric input device 920 (e.g., a keyboard), a cursor control device 930 (e.g., a mouse), a drive unit 940 (e.g., solid state drive (SSD), hard disk drive, Digital Versatile Disk (DVD) drive, or flash drive), a sensing device 950 (e.g., a speaker) and a network interface device 990.

In some embodiments, the machine 900 is includes the sensing device 104.

In some embodiments, the video display 910 includes a touch-sensitive screen for user input. In some embodiments, the touch-sensitive screen is used instead of a keyboard and mouse. The drive unit 940 includes a machine readable medium 942 on which is stored one or more sets of instructions 944 (e.g. software) embodying any one or more of the methods or functions of the inventive subject matter.

The instructions 944 may also reside, completely or partially, on machine-readable media within the main memory 940 and within machine-readable media within the processor 960 during execution thereof by the machine 900. The instructions 944 may also be transmitted or received over a network 995 via the network interface device 990. In some embodiments, the main memory 970 and the machine-readable medium 942 also includes a data 946 including the scan information or the point clouds.

While the machine-readable medium 942 is shown in an exemplary embodiment to be a single medium, the term “machine-readable medium” should be taken to include a single medium or multiple media (e.g., a centralized or distributed database, and/or associated caches and servers) that store the one or more sets of instructions and/or data. The term “machine readable medium” shall also be taken to include any non-transitory medium that is capable of storing, encoding or carrying a set of instructions for execution by the machine and that cause the machine to perform any one or more of the methods or functions of the inventive subject matter. The term “machine-readable medium” shall accordingly be taken to include, but not be limited to, solid-state memories, optical and magnetic media, and other non-transitory tangible media.

In general, the methods executed to implement the embodiments of the disclosure, may be implemented as part of an operating system or a specific application, component, program, object, module or sequence of instructions referred to as “programs.” For example, one or more programs may be used to execute specific processes according to the inventive subject matter. The programs typically comprise one or more instructions set at various times in various memory and storage devices in the machine, and that, when read and executed by one or more processors, cause the machine to perform operations to execute methods, functions and other elements of the inventive subject matter.

Moreover, while embodiments have been described in the context of machines, those skilled in the art will appreciate that the various embodiments are capable of being distributed as a program product in a variety of forms, and that the disclosure applies equally regardless of the particular type of machine or computer-readable media used to actually effect the distribution. Examples of machine-readable media include, but are not limited to, recordable type media such as volatile and non-volatile memory devices, solid state drives (SSDs), flash memory devices, floppy and other removable disks, hard disk drives, and optical disks such as Compact Disk Read-Only Memory (CD-ROMS) and Digital Versatile Disks (DVDs), among others.

What is claimed is:

1. A system for generating electronic advertisements for wearables customized for a selected user on a network, the system comprising:
A server coupled to receive requests for advertisements from the first server and communicate to the selected user on the network, the second server comprising:
a first database configured to store a plurality of user models, each user model being a three-dimensional model of a portion of a human body;
a second database configured to store a plurality of wearable models, each wearable model being a three-dimensional model of a wearable;
a third database configured to store advertising campaigns;
a processor configured to:
receive a three-dimensional model of a portion of a human body and the model of the wearable for an associated user;
morph the clothing to fit the personalized data for the target user in response to the sharing request; and
render the image of the clothed body.

2. The system of claim 1 wherein a device is communicatively coupled to the server to receive information about inventory status of an advertised wearable of a size for the associated user at a plurality of retail locations.

3. The system of claim 1 wherein the server comprises a database comprising a plurality of stored clothing models, the system further comprising a device is communicatively coupled to the first server to allow the user to add, remove, or replace clothing on the three-dimensional model with a plurality of clothing stored in the database.
